(19) United States
(12) Patent Application Publication
(10) Pub. No.: US 2026/0348434 A1
(43) Pub. Date: Nov. 5, 2026

(54) TORSIONAL VIBRATION-DAMPING COUPLING AND USE THEREOF

(71) Applicant: SAUDI ARABIAN OIL COMPANY, Dhahran (SA)

(72) Inventor: Eyad Mohammad Alkhateeb, Dhahran (SA)

(73) Assignee: SAUDI ARABIAN OIL COMPANY, Dhahran (SA)

(21) Appl. No.: 19/198,450

(22) Filed: May 5, 2025

(51) Int. Cl. F16D 3/12; F16D 3/76

(52) U.S. Cl. CPC F16D 3/12; F16D 3/76; F16D 2300/22

(57) ABSTRACT

A system includes an outer sleeve, inner sleeve, ring, and damping element. The outer sleeve extends along an axis and includes upper and lower portions. The outer sleeve further includes clamps fixed to the upper and lower portions to form a chamber. A first end of the outer sleeve has an inner circumference with a circumferentially-periodic pattern. The inner sleeve is disposed within the chamber. The ring is disposed around or adjacent to a first end of the inner sleeve and recessed within the first end of the outer sleeve. The ring has an outer circumference with the circumferentially-periodic pattern. The damping element is disposed around the ring. The system is configured to rotate around the axis. The damping element is configured to transmit a first portion of a torque of the rotating system based on a first damping coefficient and first stiffness of the damping element.

### BACKGROUND

Rotating equipment trains (RET) are used in many industries such as the oil and gas industry, automotive industry, manufacturing industry, aerospace industry, power generation industry, etc. A rotating equipment coupling (REC) may couple two RETs or portions thereof together. For example, an REC may couple a driver and driven together such that the driver rotates the driven.

During starting and/or operation of the RETs, excitation of torsional natural frequencies may occur within or between parts of the RETs (e.g., driver and driven machinery) that could cause unwanted torsional vibrations and resonances within the RETs or subcomponents thereof. These torsional vibrations cause torsional-twisting oscillations of parts or equipment relative to one another that may produce excessive shear stresses and fatigue failures. RECs are typically used to tune-out or dampen the torsional excitations or RET natural torsional modes to avoid failures and reduce stresses. Tuning-out torsional vibrations and resonances is typically achieved during design of RECs by selecting stiffness of RECs and/or using a damper REC having torsional vibration damping elements. However, once a design is selected and fabricated, it is impractical to modify, in case it turns out to be inaccurate, without extensive schedule delay and re-design/fabrication for replacement of the REC or its sub-components. Moreover, torsional vibration may be particularly problematic by causing unnecessary wear and tear on the REC or portions thereof to thereby reduce the life of the REC.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a system. The system includes an outer sleeve, inner sleeve, ring, and damping element. The outer sleeve extends along an axis. The outer sleeve includes upper and lower portions. The outer sleeve further includes clamps fixed to the upper and lower portions such that the upper and lower portions form a chamber. A first end of the outer sleeve has an inner circumference with a circumferentially-periodic pattern. The inner sleeve is disposed within the chamber. The ring is disposed around or adjacent to a first end of the inner sleeve and recessed within the first end of the outer sleeve. The ring has an outer circumference with the circumferentially-periodic pattern. The damping element is disposed around the ring. The first end of the outer sleeve is clamped around the damping element and ring using the clamps. The system is configured to rotate around the axis. The damping element is configured to transmit a first portion of a torque of the rotating system based on a first damping coefficient and first stiffness of the damping element.

In general, in another aspect, embodiments relate to another system. The system includes an outer sleeve, inner sleeve, ring, and damping element. The outer sleeve extends along an axis and has a chamber. A first end of the outer sleeve has an outer circumference with a circumferentially-periodic pattern. The inner sleeve is disposed within the chamber. The damping element is disposed around the first end of the outer sleeve. The ring is clamped around the damping element. The ring includes two portions. The ring has an inner circumference with the circumferentially-periodic pattern. The system is configured to rotate around the axis. The damping element is configured to transmit a first portion of a torque of the rotating system based on a first damping coefficient and first stiffness of the damping element.

In general, in still another aspect, embodiments relate to a method. The method includes rotating a system around an axis. The system includes an outer sleeve, inner sleeve, damping element, and ring. The outer sleeve extends along the axis and has a chamber. A first end of the outer sleeve has a circumference with a circumferentially-periodic pattern. The inner sleeve is disposed within the chamber. The damping element is disposed within or around the first end of the outer sleeve. The ring is disposed within or around the damping element. The ring has a circumference with the circumferentially-periodic pattern. The method further includes transmitting, using the damping element, a first portion of a torque of the rotating system based on a first damping coefficient and a first stiffness of the damping element.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a standard damper rotating equipment coupling (REC) with torsional vibration-damping elements.

FIG. 2A illustrates a damper element and other torque-transmitting components in series.

FIG. 2B illustrates the damper element and other torque-transmitting components in parallel in accordance with one or more embodiments.

FIGS. 3A-3C illustrate a parallel-configuration, torsional vibration-damping REC with adjustable torsional stiffness and damping in accordance with one or more embodiments.

FIGS. 4A-4C illustrate a damping element in accordance with one or more embodiments.

FIG. 5 illustrates a parallel-configuration, torsional vibration-damping REC with adjustable torsional stiffness and damping in accordance with one or more embodiments.

FIGS. 6A and 6B illustrate a parallel-configuration, torsional vibration-damping REC with adjustable torsional stiffness and damping in accordance with one or more embodiments.

FIG. 7 describes a method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a damping element” includes reference to one or more of such damping elements.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

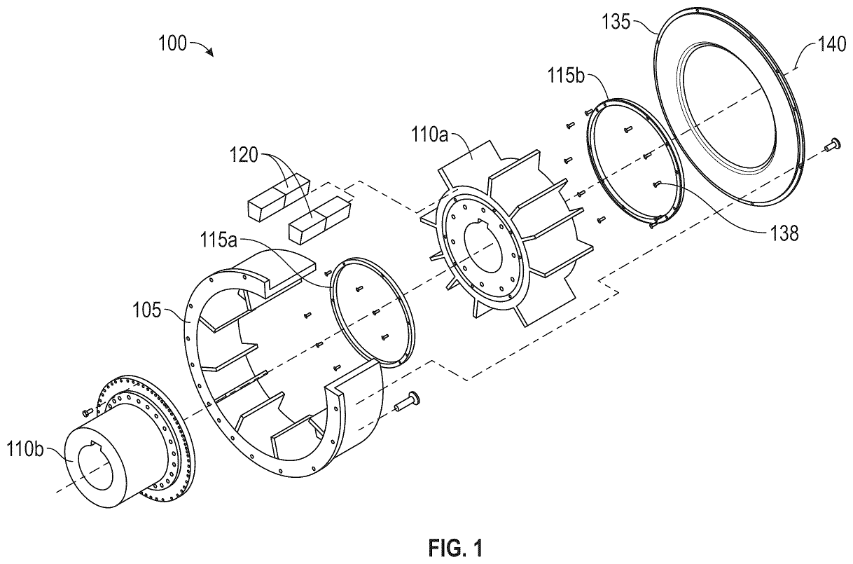

In the following description of FIGS. 1-7, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

A parallel-configuration, torsional vibration-damping coupling and use thereof are disclosed. Hereinafter, the parallel-configuration, torsional vibration-damping coupling may also be referred to as at least a rotating equipment coupling (REC) or portion thereof, simply a “coupling,” or even more generically a “system.” The coupling includes a disclosed torsional-damping element. Hereinafter, the disclosed torsional-damping element may also be referred to as simply a “damping element.” The damping element is different than a standard damping element. The damping element is disposed within the REC. In contrast, the standard damping element is disposed within a standard REC. Any REC is configured to couple, connect, or fix driver equipment and one or more driven equipment together to facilitate the transmission of energy. The REC is further configured to rotate with the driver equipment and one or more driven equipment. The driver equipment and one or more driven equipment and transmission components thereof, separately or collectively, may be referred to as a rotating equipment train (RET).

For example, the driver equipment may include a motor and first shaft fixed together. The driven equipment may include a second shaft and gear fixed together. The motor is configured to rotate the first shaft around its long axis. In turn, the rotating first shaft rotates the REC and second shaft to rotate the gear. However, a person of ordinary skill in the art will appreciate that the disclosed REC with damping element may be used with any driver equipment and driven equipment, or between multiple driven equipment, that are rotating around an axis. Accordingly, the type of driver equipment and driven equipment should not be limiting. As such, the disclosed REC with damping element may be used in any industry where RECs are used. Industries may include, but are not limited to, the oil and gas industry, petrochemical industry, automotive industry, manufacturing industry, aerospace industry, energy storage and power generation industry, and construction industry. No matter the type or industry of the RET, the RET and, thus, REC may rotate continuously or intermittently. For example, intermittent rotation in the form of frequent start-stop operations may occur when the REC is used with fire-water jockey pumps.

FIG. 1 illustrates a standard REC 100. This exploded view of the standard REC 100 includes a sleeve 105, first hub 110a, first bushing 115a, rubber blocks 120, second hub 110b, second bushing 115b, end ring 135, and various attachments 138, such as nuts and bolts. The rubber blocks 120 are disposed between the sleeve 105, first bushing 115a, and first hub 110a. The rubber blocks 120 are configured to dampen unwanted torsional vibration of the standard REC 100 while the REC is rotating. The rubber blocks 120 are a type of damper block. The rubber blocks 120 may be viscous or elastomeric damping elements with a predetermined stiffness, predetermined damping coefficient, and other predetermined mechanical properties. During operation of the standard REC 100, the standard REC 100 is rotating around an axis 140.

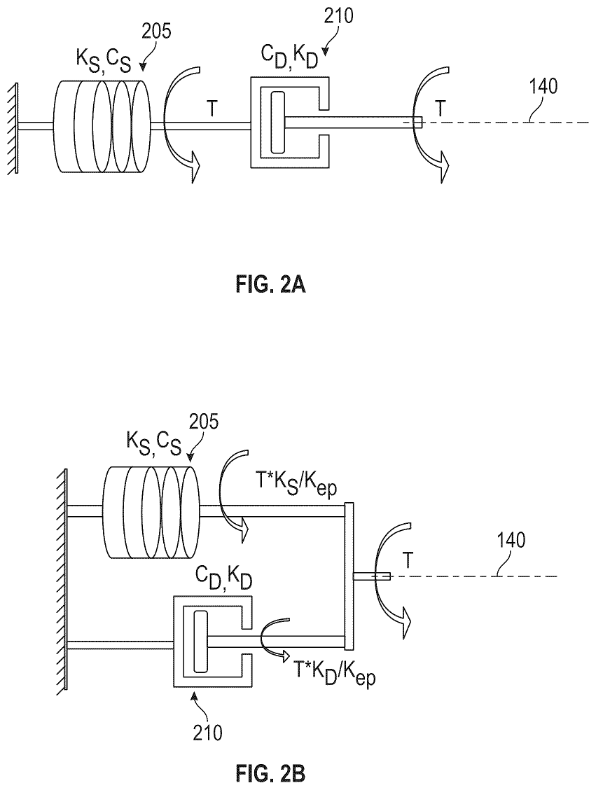

Use of the rubber blocks 120 or other standard damping elements have several disadvantages. One, the rubber blocks 120 degrade when exposed to standard RCE-operating temperatures (that may be high), air, and/or oil (that includes oil mist). Two, the predetermined mechanical properties of the rubber blocks 120 are fixed (i.e., not adjustable in situ) and difficult to design. To change the predetermined mechanical properties, the rubber blocks 120 need to be removed and replaced with new rubber blocks 120 or other standard damping elements that have different predetermined mechanical properties. Three, other standard damping elements in the form of lubricants (e.g., fluid) may be needed for viscous torsional damping, which may leak during operation of the standard REC 100. Four, it costs time and money to retrofit the standard REC 100 and coupled RET when no damping element exists or replacement of the standard damping element that has degraded is needed. Five, standard damping elements may experience problems in the field, such as imbalance and lateral vibrations, that require the standard REC 100 to be frequently, periodically, and tediously maintained with chances of repeating maintenance work and trial-and-error attempts to thereby cause long downtime of the entire RET as it cannot be started without the standard REC 100. Six, the rubber blocks 120 may be difficult to replace in situ (i.e., in service in the field), if at all, to adequately dampen torsional vibration. Seven, the rubber blocks 120 may experience unwanted vibrations as the rubber blocks 120 wear (e.g., crack or disintegrate). Eight, components of the standard REC 100 are arranged in series (i.e., the entire amount of torque and/or forces are/is transmitted through the rubber blocks 120 to thereby highly stress the rubber blocks 120 and cause faster wear and more frequent maintenance. Nine, the rubber blocks 120 damping and stiffness mechanical properties are in series with other components of the standard REC 100 as described relative to FIG. 2A. As such, the overall effective damping coefficient and stiffness of the standard REC 100 are lowered such that the size and cost associated with the transmitted torque and power increases.

FIG. 2A illustrates damper element 210 and other torque-transmitting components (OTTC) 205 placed in series. The damper element 210 has a relatively-high damping C_{D} and low stiffness K_{D}. The OTTC 205 has a relatively-high lumped stiffness K_{S} and low damping C_{S}. Placing the damper element 210 and OTTC 205 in series causes each to transmit the same amount of torque. However, doing so lowers the overall effective damping coefficient Cₑₛ such that it is always lower than the lowest of C_{D} and C_{S}. Further, doing so lowers the overall effective stiffness Kₑₛ such that it is always lower than the lowest of K_{D} and K_{S}. As such:

$${C}_{es} = \frac{1}{\frac{1}{{C}_{S}} + \frac{1}{{C}_{S}}} , and \qquad Equation ( 1 )$$

$${K}_{es} = \frac{1}{\frac{1}{{K}_{S}} + \frac{1}{{K}_{S}}} , \qquad Equation ( 2 )$$

where C_{S} is the damping coefficient of the OTTC 205, C_{D} is the damping coefficient of the damper element 210, K_{S} is the stiffness of the OTTC 205, and K_{D} is the stiffness of the damper element 210. FIG. 2A further illustrates total torque T along axis 140, which is the main torque transmission path.

The disclosed REC has several advantages. Inclusion of the disclosed torsional-damping element within the disclosed REC dampens torsional vibrations in parallel with the OTTC 205. FIG. 2B generically illustrates the disclosed torsional-damping element as the damper element 210 in parallel with the OTTC 205 in accordance with one or more embodiments. In doing so, the damper element 210 and OTTC 205 experience the same torsional deflection (i.e., angular deflection) but different amounts of torque. Placing the damper element 210 and OTTC 205 in parallel provides additive accumulation of component damping and stiffness, which increases the overall effective damping coefficient Cₑₚ and overall effective stiffness Kₑₚ such that:

Cₑₚ=C_{S}+C_{D}, and Equation (3)

Kₑₚ=K_{S}+K_{D}, Equation (4)

where Cₑₚ is always greater than Cₑₛ. FIG. 2B further illustrates the total torque T along axis 140, which splits proportionally to a torque value of

$$T \cdot \frac{{K}_{s}}{{K}_{ep}}$$

that is transmitted via OTTC 205, and a torque value of

$$T \cdot \frac{{K}_{D}}{{K}_{ep}}$$

that is transmitted via the damper element 210 to hence lower the torque and stress applied to the damper element 210 compared to when the damper element 210 is in series with the OTTC 205 as illustrated in FIG. 2A. Accordingly, the disclosed damping element provides higher overall effective damping while lowering the stress on the damping element without negatively impacting torsional stiffness. Further, the disclosed damping element is parallel to the main torque transmission path and, thus, independent in terms of mechanical properties and tuning flexibility. As such, designing or tuning the stiffness and damping of the REC can easily be done by simple selection, adjustment, or replacement of the damping element. Furthermore, less (i.e., only a portion) of the stress and torque of the disclosed REC is transmitted to the disclosed torsional-damping element.

Continuing with advantages of the disclosed torsional-damping element compared to standard damping elements, the disclosed torsional-damping element does not degrade when exposed to standard RCE-operating temperatures, air, and/or oil to thereby be more reliable, have a longer life, and require less, simpler, and faster maintenance. Accordingly, less maintenance means less downtime. The disclosed torsional-damping element is easier to design and construct. The mechanical properties of the disclosed torsional-damping element (e.g., damping coefficient and stiffness) are adjustable in situ due to the design of the disclosed torsional-damping element, ring, and outer sleeve of the disclosed REC. Accordingly, the disclosed torsional-damping element can be more accurately tuned in situ. This may be useful when the disclosed torsional-damping element is used within an REC or RET that was designed based on certain assumptions about, for example, a stiffness, damping coefficient, natural frequencies, or natural resonances that end up being inaccurate during operation. As such, tuning the disclosed torsional-damping element may correct for these inaccuracies. The disclosed torsional-damping element will not leak unlike lubricant damping elements. The disclosed torsional-damping element is also easier to retrofit to any REC already installed within an RET or that is available on the market with flexible elements as minimal modifications may be needed. The disclosed torsional-damping element may also cost less as it may be smaller and lighter. As such, the disclosed damping element may outperform standard damping elements.

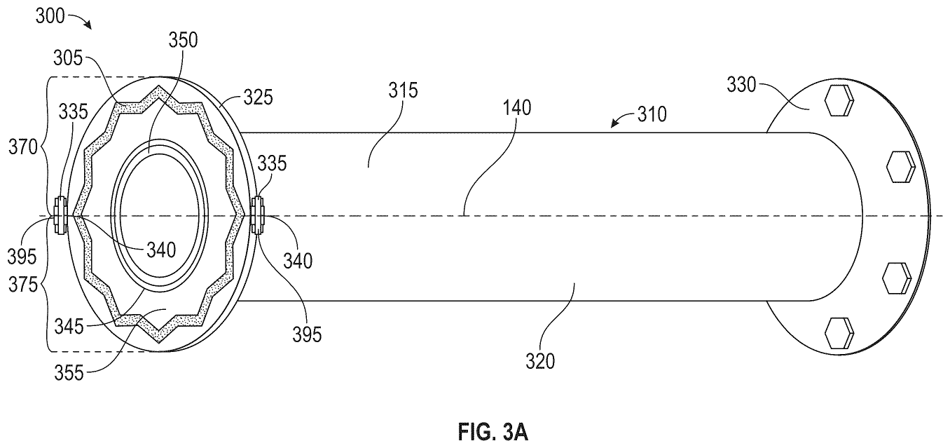

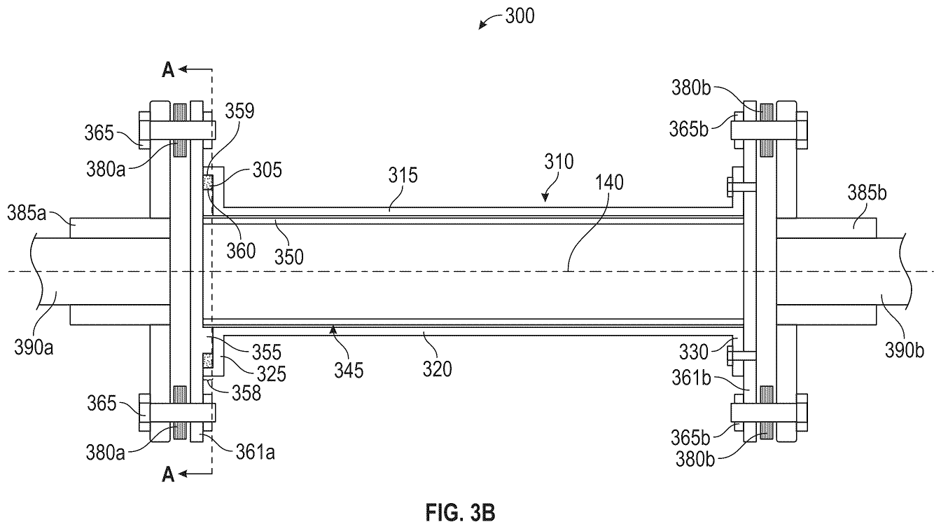

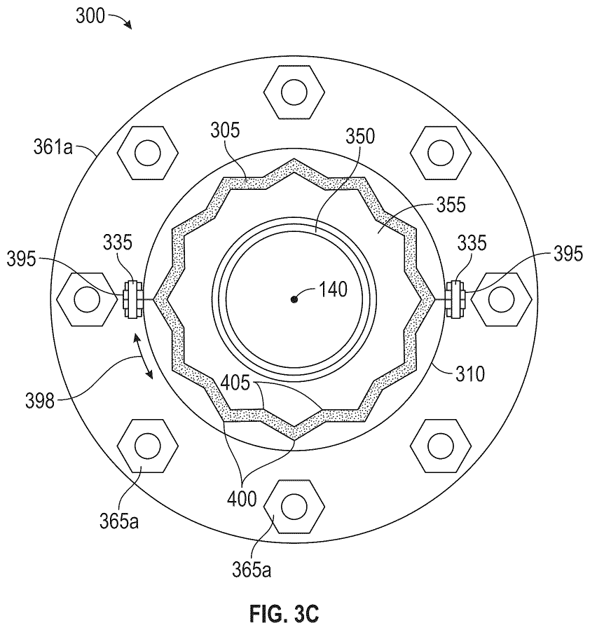

FIGS. 3A-3C illustrate the disclosed REC 300 with disclosed torsional-damping element 305 in accordance with one or more embodiments. The disclosed REC 300 may also be referred to as a torsional vibration-damping REC.

FIG. 3A illustrates an isometric view of the disclosed REC 300 in accordance with one or more embodiments. The REC 300 includes an outer sleeve 310 that extends along an axis 140. In some embodiments, the outer sleeve 310 has a circular cross-section perpendicular to the axis 140 as FIG. 3A illustrates. In some embodiments, the outer sleeve 310 is separated or split into an upper portion 315 and lower portion 320. In some embodiments, the upper portion 315 and lower portion 320 are substantially similar and have a semicircular cross-section perpendicular to the axis 140 as FIG. 3A illustrates. The upper portion 315 resides on and above a plane that intersects the axis 140. The lower portion 320 resides on and below the plane. The plane may be at any angle relative to the axis 140. The outer sleeve 310 has a first end 325 and second end 330. Accordingly, the upper portion 315 and lower portion 320 have the first end 325 and second end 330. Each of the first end 325 and second end 330 may take the form of a semicircular flange as FIG. 3A illustrates. Further, an inner circumference of the first end 325 of the outer sleeve 310 may have a circumferentially-periodic pattern as further described below.

The upper portion 315 and lower portion 320 of the outer sleeve 310 are fixed together using clamps 335. A portion of each clamp 335 is fixed to each endpoint 340 of the semicircular flange of the upper portion 315 and lower portion 320 as illustrated at the first end 325 in FIG. 3A. Though not shown in FIG. 3A, two additional clamps may be fixed on the second end 330. Further, in some embodiments, additional clamps may be fixed along the length of the upper portion 315 and lower portion 320. Each portion of one clamp 335 may be fixed together using an attachment, such as a nut and bolt, as FIG. 3A illustrates. Hereinafter, these attachments are considered as part of the clamps 335. When the upper portion 315 and lower portion 320 are attached using the clamps 335, they form a chamber 345.

The REC includes an inner sleeve 350. The inner sleeve 350 is disposed within the chamber 345 of the outer sleeve 310. The inner sleeve 350 has a first end that corresponds to the first end 325 of the outer sleeve 310. The inner sleeve 350 has a second end that corresponds to the second end 330 of the outer sleeve 310. However, in some embodiments, the first end of the inner sleeve 350 may extend along the axis 140 beyond the first end 325 of the outer sleeve 310 though not clearly illustrated in FIG. 3A.

The REC 300 includes a ring 355. In some embodiments, the ring 355 is disposed around and/or adjacent to the first end of the inner sleeve 350. In other embodiments, the ring 355 and inner sleeve 350 are one piece (i.e., integral) as FIGS. 3A-3C illustrate. In some embodiments, the ring 355 is recessed within the first end 325 of the outer sleeve 310. In some embodiments, the outer circumference of the ring 355 has the circumferentially-periodic pattern that corresponds to the circumferentially-periodic pattern of the inner circumference of the first end 325 of the outer sleeve 310. FIG. 3A specifically illustrates that the circumferentially-periodic pattern is triangular.

The REC 300 also includes the damping element 305. In some embodiments, the damping element 305 is disposed around the ring 355. A first portion 370 of the damping element 305 corresponds to the upper portion 315 of the outer sleeve 310. A second portion 375 of the damping element 305 corresponds to the lower portion 320 of the outer sleeve 310. By disposing the damping element 305 around the ring 355 and recessing the damping element 305 and ring 355 within the first end 325 of the outer sleeve 310, the upper portion 315 and lower portion 320 of the outer sleeve 310 radially compress or clamp around the damping element 305 and ring 355. In turn, the first end 325 of the outer sleeve 310 clamps the damping element 305 around the first ring 355 to thereby compress the damping element 305 to shape it into the circumferentially-periodic pattern.

In some embodiments, the damping element 305 may be separated into multiple portions circumferentially around the ring 355. Disadvantageously, doing so may complicate assembly and/or disassembly of the REC 300. Advantageously, doing so may allow for individual portions of the damping element 305 to be replaced. Further advantageously, each portion of the damping element 305 may be designed differently (e.g., by using different materials) such that each portion has a unique stiffness and damping. For example, it may be advantageous to design a portion of the damping element 305 that has concentrated wire mesh (detailed below) compared to other portions and disposed within the REC 300 in high-deflection areas. Doing so may lower the weight of the damping element 305 to thereby lower the cost.

In some embodiments, the damping element 305 may include wire mesh. The wire mesh may be formed by wires of metal or of other damping material that does not degrade at high temperatures, due to air or oil, or over time. The wires may be repeatedly folded to form the damping element 305 with a predetermined thickness (not shown in FIG. 3A). The repeated folds may be periodic, such as knitted, or random. The wires may be repeatedly folded such that the damping element 305 has a predetermined damping coefficient and predetermined stiffness.

Prior to disposing the damping element 305 within the REC 300, the damping element 305 may be or take the form of a hollow cylinder. Once the damping element 305 is disposed within the REC 300, the first end 325 of the outer sleeve 310 and ring 355 form the damping element 305 into the circumferentially-periodic pattern.

The damping element 305 has a predetermined damping coefficient and predetermined stiffness by design. Following disposition of the damping element 305 into the REC 300, the in situ damping coefficient and in situ stiffness may be different than the predetermined damping coefficient and predetermined stiffness.

FIG. 3B illustrates a side view of the disclosed REC 300 in accordance with one or more embodiments. As previously described, the inner sleeve 350 is disposed within the chamber 345 formed by the upper portion 315 and lower portion 320 of the outer sleeve 310. The ring 355 and damping element 305 are disposed around the first end of the inner sleeve 350 and recessed within the first end 325 of the outer sleeve 310. The damping element 305 has predetermined dimensions that include the predetermined thickness 358.

In some embodiments, the first end 325 of the outer sleeve 310 has an inner circumference 359 with the circumferentially-periodic pattern. In these embodiments, the ring 355 has an outer circumference 360 with the circumferentially-periodic pattern. Accordingly, when the damping element 305 is disposed around the ring 355 and the outer sleeve 310 clamped around the damping element 305 and ring 355, the ring 355 and outer sleeve 310 form the damping element 305 to have the circumferentially-periodic pattern as shown in FIG. 3C.

In some embodiments, the REC 300 further includes a flange 361a. The flange 361a is disposed adjacent to the first end 325 of the outer sleeve 310 and the ring 355. The flange 361a and ring 355 may be fixed together using attachments (not shown in FIG. 3B) disposed radially around the two. In other embodiments, the flange 361a and ring 355 may be one piece (i.e., integral) as FIG. 3B illustrates. However, it may be advantageous for the flange 361a and ring 355 to be separate such that the ring 355 may added to existing RECs or changed out for a ring 355 with a different circumferentially-periodic pattern.

In some embodiments, the REC 300 further includes two or more flexible elements 380a disposed adjacent to the flange 361a. The two or more flexible elements 380a are disposed radially around the flange 361a and through attachments 365. In some embodiments, the two or more flexible elements 380a may be shim-packs or flexible diaphragms.

In some embodiments, the REC 300 further includes a hub 385a. The hub 385a is disposed adjacent to the two or more flexible elements 380a and through the attachments 365. The hub 385a extends along the axis 140 opposite to the inner sleeve 350 and outer sleeve 310. The hub 385a may be fixed to a shaft 390a. The shaft 390a may be a part of the driver or driven of an RET.

In some embodiments, the REC 300 further includes two or more attachments 365a. The two or more attachments 365a fix the hub 385a, two or more flexible elements 380a, and flange 361a together.

In some embodiments, the ring 355, damping element 305, flange 361a, two or more flexible elements 380a, hub 385a, two or more attachments 365a, shaft 390a, or portion thereof may also be disposed adjacent to or fixed to the second end 330 of the outer sleeve 310. In other words, the parts at the first end of the REC 300 mirror the parts at the second end of the REC 300. In other embodiments, a flange 361b, two or more second flexible elements 380b, hub 385b, shaft 390b, or portion thereof may be disposed adjacent to or fixed to the second end 330 of the outer sleeve 310 using two or more second attachments 365b as FIG. 3B illustrates. The shaft 390b may be a part of the driver or driven of an RET.

The REC 300 is configured to rotate around the axis 140. In some embodiments, a driver fixed to the shaft 390a may apply a torque to rotate the shaft 390a and REC 300 around the axis 140.

While rotating, the REC 300 may experience unwanted torsional vibration (i.e., oscillation) superimposed on the rotating REC 300. In some embodiments, the unwanted torsional vibration may be between the first end 325 and second end 330 of the REC 300 such that there is angular (torsional) motion between the inner sleeve 350 and first end 325 of outer sleeve 310. In some embodiments, the outer sleeve 310 or portion thereof may be torsionally vibrating relative to the inner sleeve 350.

The damping element 305 is configured to dampen (i.e., reduce, absorb, attenuate) the unwanted torsional vibration. Prior to disposing the damping element 305 within the REC 300, the damping element 305 has the predetermined damping coefficient and predetermined stiffness. Following disposition of the damping element 305 within the REC 300, the in situ damping coefficient and in situ stiffness of the damping element 305 may be different. In some embodiments, one or more of the clamps 335 may be loosened or tightened to adjust the in situ damping coefficient and in situ stiffness by varying the static stress applied radially around the damping element 305. In other embodiments, one or more shims 395 may be disposed between the one or more clamps 335 to effectively loosen the one or more clamps 335 to thereby adjust the in situ damping coefficient and in situ stiffness by reducing the static stress applied radially around the damping element 305. In still other embodiments, one or more shims 395 previously disposed between the one or more clamps 335 may be removed to effectively tighten the one or more clamps 335 to thereby adjust the in situ damping coefficient and in situ stiffness by increasing the static stress applied radially around the damping element 305. As such, in some embodiments, the REC 300 may include one or more shims 395. Hereinafter, the in situ damping coefficient and in situ stiffness of the disposed damping element 305, which may change and/or may be the predetermined damping coefficient and predetermined stiffness, is generically referred to using ordinal numbers. Further, hereinafter, the loosening or tightening of one or more clamps 335 or the adding or removing of one or more shims 395 may be generically referred to as “adjusting” or “tuning” the damping element 305 in situ.

By separating the outer sleeve 310 from the inner sleeve 350, only a portion of the torque is transmitted through the damping element 305. In using the damping element 305 to transmit a portion of the torque, stress and wear of the damping element 305 are reduced.

Due to the split-portion design of the outer sleeve 310 and disclosed torsional-damping element 305, the damping coefficient and stiffness of the inner sleeve 350 are in parallel with the damping coefficient and stiffness of the disclosed torsional-damping element 305 and outer sleeve 310. In other words, statically, the inner sleeve 350 and outer sleeve 310 have the same angular deflection at the second end 330 and flange 361b while the applied torque is split between the inner sleeve 350 and outer sleeve 310 proportionally.

FIG. 3C illustrates a front view of the AA section of the REC 300 in accordance with one or more embodiments. The AA section lines are shown in FIG. 3B for reference. In FIG. 3C, the axis 140 extends into and out of the page. As such, the bidirectional arrow 398 shows the direction of rotation and torsional vibration of the REC 300.

Eight attachments 365a are disposed radially around the flange 361a. The ring 355 is disposed around the first end of the inner sleeve 350 and recessed within the first end 325 of the outer sleeve 310. The damping element 305 is disposed around the ring 355.

In the embodiments shown in FIG. 3C, the circumferentially-periodic pattern of the outer circumference of the ring 355 and damping element 305 is triangular. Accordingly, the damping element 305 has peaks 400 and troughs 405. The peaks 400 of the damping element 305 form the outer circumference of the damping element 305 (as defined by an outer diameter). The troughs 405 form the inner circumference of the damping element 305 (as defined by an inner diameter). FIG. 3C illustrates the outer circumference of the damping element 305 not contracting the outer sleeve 310. Further, the inner circumference of the damping element 305 may or may not contact the inner sleeve 350. FIG. 3C illustrates the inner circumference of the damping element 305 not contacting the inner sleeve 350.

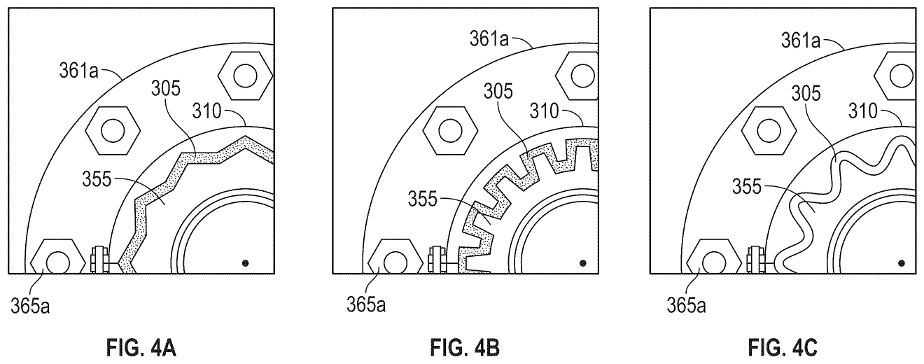

FIGS. 4A-4C illustrate a portion of the front view of the AA section of the REC 300 in accordance with one or more embodiments. Each portion illustrates the outer circumference of the ring 355 and damping element 305 with a unique circumferentially-periodic pattern.

FIG. 4A illustrates the outer circumference of the ring 355 and damping element 305 where the circumferentially-periodic pattern is triangular as previously shown. FIG. 4B illustrates the outer circumference of the ring 355 and damping element 305 where the circumferentially-periodic pattern is square. FIG. 4C illustrates the outer circumference of the ring 355 and damping element 305 where the circumferentially-periodic pattern is sinusoidal (i.e., wavy). However, a person of ordinary skill in the art will appreciate that the circumferentially-periodic pattern of the outer circumference of the ring 355 and damping element 305 may take other circumferentially-periodic patterns such as, but not limited to, triangular, square, sinusoidal, sawtooth, and rectified. The circumferentially-periodic pattern may have any amplitude and any period without departing from the scope of the disclosure.

The damping element 305 illustrated in FIGS. 4A and 4B include wire mesh. The damping element 305 illustrated in FIG. 4C includes other damping material that does not degrade at high temperatures, due to air or oil, or over time.

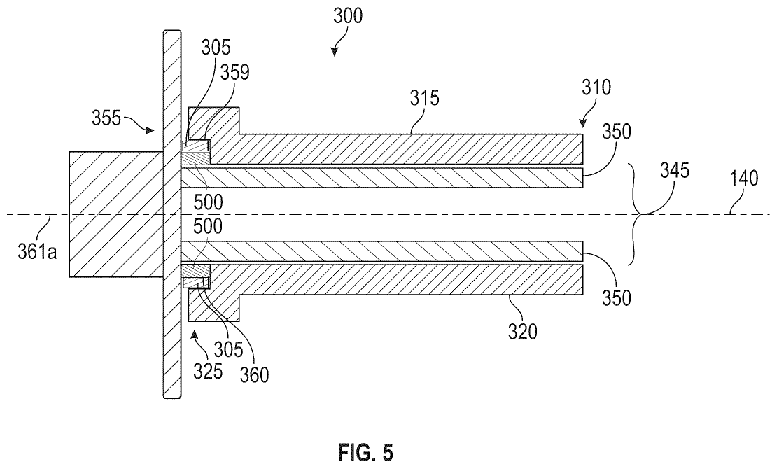

FIG. 5 illustrates a side view of the disclosed REC 300 in accordance with one or more embodiments. The outer sleeve 310 extends along the axis 140. The outer sleeve 310 includes the upper portion 315 and lower portion 320. Though not shown in FIG. 5, the upper portion 315 and lower portion 320 are fixed together using the clamps 335 such that the upper portion 315 and lower portion 320 form the chamber 345.

The first end 325 of the outer sleeve 310 has the inner circumference 359 with the circumferentially-periodic pattern. An inner ring 500 has the outer circumference 360 with the circumferentially-periodic pattern. Accordingly, when the damping element 305 is disposed around the inner ring 500 and the outer sleeve 310 clamped around the damping element 305 and inner ring 500, the inner ring 500 and outer sleeve 310 form the damping element 305 to have the circumferentially-periodic pattern.

Note the inner ring 500 and flange 361a may be integral (i.e., one piece) that is collectively referred to as the ring 355.

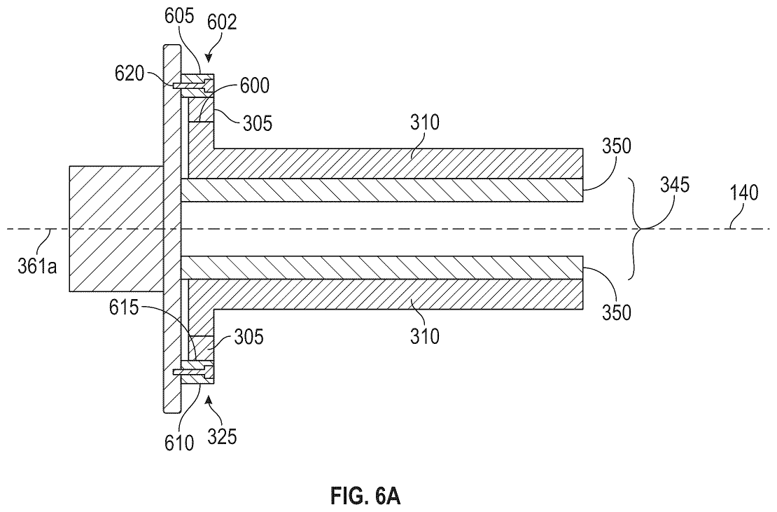

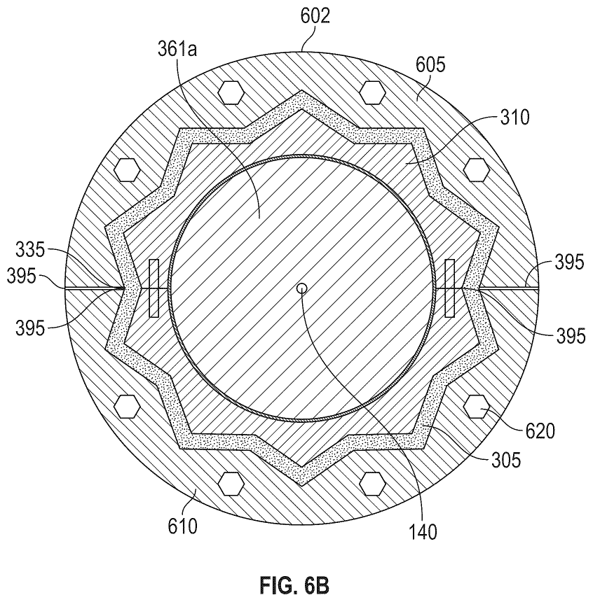

FIGS. 6A and 6B illustrate the disclosed REC 300 in accordance with one or more embodiments. FIG. 6A illustrates a side view of the disclosed REC 300. FIG. 6B illustrates a front view of the disclosed REC 300.

In these embodiments, the outer sleeve 310 extends along the axis 140. The outer sleeve 310 has the chamber 345. In some embodiments, the outer sleeve 310 includes the upper portion 315 and lower portion 320 clamped together using the clamps 335 such that the upper portion 315 and lower portion 320 form the chamber 345 as shown in FIG. 6B. In other embodiments, the outer sleeve 310 is one portion that is not separated into the upper portion 315 and lower portion 320. In these embodiments, clamps 335 are not needed. The first end 325 of the outer sleeve 310 has an outer circumference 600 with the circumferentially-periodic pattern.

The inner sleeve 350 is disposed within the chamber 345. In some embodiments, the first end of the inner sleeve 350 extends as far as the first end 325 of the outer sleeve 310 as FIG. 6A illustrates.

The damping element 305 is disposed around the first end 325 of the outer sleeve 310.

An outer ring 602 is clamped around the damping element 305. To do so, the outer ring 602 includes two portions: an upper portion 605 and lower portion 610. The outer ring 602 has an inner circumference 615 with the circumferentially-periodic pattern. Accordingly, when the damping element 305 is disposed around the first end 325 of the outer sleeve 310 and the outer ring 602 clamped around the damping element 305 and first end 325 of the outer sleeve 310, the outer ring 602 and outer sleeve 310 form the damping element 305 to have the circumferentially-periodic pattern.

In embodiments where the outer ring 602 and flange 361a are not integral, the outer ring 602 and flange 361a may be fixed together using attachments 620. In embodiments where the outer ring 602 and flange 361a are integral, the single piece may be the ring 355.

One or more shims 395 may be disposed between various portions to adjust the in situ damping coefficient and in situ stiffness by reducing the static stress applied radially around the damping element 305. In some embodiments, one or more shims 395 may be disposed between one or more clamps 335 that are clamping the upper portion 315 and lower portion 320 of the outer sleeve 310 together. In other embodiments, one or more shims 395 may be disposed between the upper portion 605 and lower portion 610 of the ring 355.

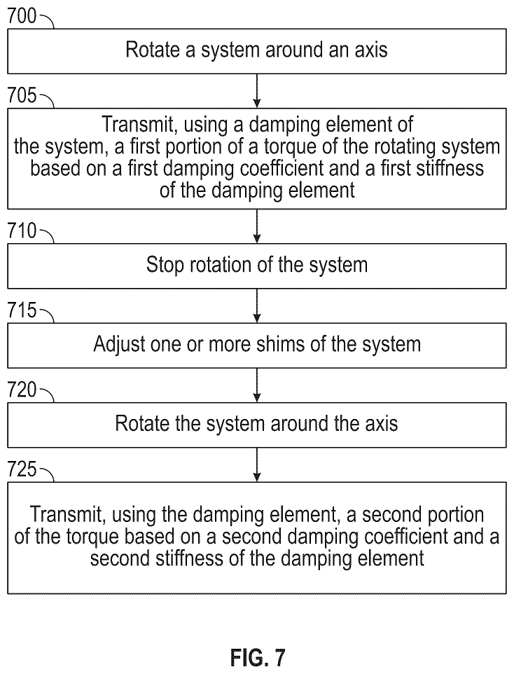

FIG. 7 is a flowchart of a method that relies on the disclosed torsional-damping element in accordance with one or more embodiments. Prior to the method described in FIG. 7, the damping element 305 is disposed within the REC 300 as previously described. Further, the damping element 305 may be tuned such that the damping element has an in situ damping coefficient and in situ stiffness.

Any of the steps of the method described hereinafter may be performed in series, performed in parallel (i.e., simultaneously), performed repeatedly, or not performed without departing from the scope of the disclosure.

In step 700, a system is rotated around an axis 140. The system is at least the disclosed REC 300 or portion thereof. Accordingly, the system may include the outer sleeve 310, inner sleeve 350, a ring (e.g., ring 355, inner ring 500, or outer ring 602), and damping element 305. The system may be rotated by a driver. Rotation of the system may cause the unwanted torsional vibration.

In step 705, the damping element 305 transmits a first portion of a torque of the rotating system based on the in situ damping coefficient and in situ stiffness of the damping element 305 (i.e., a first damping coefficient and first stiffness). To transmit a first portion of the torque, the damping element 305 may be elastically deforming (e.g., compressing, decompressing, shearing, torquing) based on the split-portion design of the ring into the upper portion 605 and lower portion 610 and/or split-portion design of the outer sleeve 310 into the upper portion 315 and lower portion 320.

In step 710, rotation of the system is stopped. That is, the driver stops rotating the REC 300.

In step 715, one or more shims 395 are adjusted. To do so, one or more shims 395 may be added or removed from between the one or more clamps 335 or from between the upper portion 605 and lower portion 610 of the ring. Adjustment of one or more shims 395 thereby tunes the damping element 305 to have a different, new in situ damping coefficient and in situ stiffness.

In step 720, the system is rotated around the axis 140.

In step 725, the damping element 305 transmits the second portion of the torque based on the new in situ damping coefficient and new in situ stiffness of the damping element 305 (i.e., a second damping coefficient and second stiffness).

In summary, the disclosed damping element 305 and use of the disclosed damping element 305 within the disclosed REC 300 offers several advantages over standard damping elements (e.g., rubber blocks 120) used within standard RECs 100. Implementing the disclosed REC 300 within an RET may benefit many industries by reducing cost, maintenance, and downtime.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system comprising:
an outer sleeve extending along an axis, the outer sleeve comprising:
an upper portion,
a lower portion, and
a plurality of clamps fixed to the upper portion and the lower portion such that the upper portion and the lower portion form a chamber,
wherein a first end of the outer sleeve has an inner circumference with a circumferentially-periodic pattern;
an inner sleeve disposed within the chamber;
a ring disposed around or adjacent to a first end of the inner sleeve and recessed within the first end of the outer sleeve,
wherein the ring has an outer circumference with the circumferentially-periodic pattern; and
a damping element disposed around the ring,
wherein the first end of the outer sleeve is clamped around the damping element and the ring using the plurality of clamps,
wherein the system is configured to rotate around the axis, and
wherein the damping element is configured to transmit a first portion of a torque of the rotating system based on a first damping coefficient and a first stiffness of the damping element.

2. The system of claim 1, further comprising a shim disposed within at least one of the plurality of clamps, and
wherein the damping element is configured to transmit a second portion of the torque of the rotating system based on a second damping coefficient and a second stiffness of the damping element.

3. The system of claim 1, further comprising a flange fixed adjacent to a second end of the outer sleeve.

4. The system of claim 1, wherein the circumferentially-periodic pattern is triangular.

5. The system of claim 1, wherein the damping element comprises a wire mesh.

6. The system of claim 1, wherein the damping element is configured to transmit the first portion of the torque of the rotating system to thereby dampen a torsional vibration between the first end of the outer sleeve and the first end of the inner sleeve.

7. The system of claim 1, wherein the ring comprises an inner ring and a flange, and
wherein the inner ring is disposed around the first end of the inner sleeve and recessed within the first end of the outer sleeve.

8. A system comprising:
an outer sleeve extending along an axis and having a chamber,
wherein a first end of the outer sleeve has an outer circumference with a circumferentially-periodic pattern;
an inner sleeve disposed within the chamber;
a damping element disposed around the first end of the outer sleeve; and
a ring clamped around the damping element and comprising two portions,
wherein the ring has an inner circumference with the circumferentially-periodic pattern;
wherein the system is configured to rotate around the axis, and
wherein the damping element is configured to transmit a first portion of a torque of the rotating system based on a first damping coefficient and a first stiffness of the damping element.

9. The system of claim 8, further comprising a shim disposed between the two portions,
wherein the damping element is configured to transmit a second portion of the torque of the rotating system based on a second damping coefficient and a second stiffness of the damping element.

10. The system of claim 8, wherein the outer sleeve comprises an upper portion, a lower portion, and a plurality of clamps fixed to the upper portion and the lower portion such that the upper portion and the lower portion form the chamber.

11. The system of claim 10, further comprising a shim disposed within at least one of the plurality of clamps,
wherein the damping element is configured to transmit a second portion of the torque of the rotating system based on a second damping coefficient and a second stiffness of the damping element.

12. The system of claim 8, further comprising:
a flange disposed adjacent to the ring; and
a plurality of attachments configured to fix the ring and the flange together.

13. The system of claim 8, wherein the ring comprises an outer ring and a flange, and
wherein the outer ring is clamped around the damping element.

14. The system of claim 8, wherein the damping element is configured to transmit the first portion of the torque of the rotating system to thereby dampen a torsional vibration between the first end of the outer sleeve and a first end of the inner sleeve.

15. A method comprising:
rotating a system around an axis, the system comprising:
an outer sleeve extending along the axis and having a chamber,
wherein a first end of the outer sleeve has a circumference with a circumferentially-periodic pattern,
an inner sleeve disposed within the chamber,
a damping element disposed within or around the first end of the outer sleeve, and
a ring disposed within or around the damping element,
wherein the ring has a circumference with the circumferentially-periodic pattern; and
transmitting, using the damping element, a first portion of a torque of the rotating system based on a first damping coefficient and a first stiffness of the damping element.

16. The method of claim 15, further comprising:
stopping rotation of the system;
adjusting a shim of the system;
rotating the system around the axis;
transmitting, using the damping element, a second portion of the torque of the rotating system based on a second damping coefficient and a second stiffness of the damping element.

17. The method of claim 16, wherein adjusting the shim comprises disposing the shim between an upper portion and a lower portion of the outer sleeve.

18. The method of claim 16, wherein adjusting the shim comprises disposing the shim between two portions of the ring.

19. The method of claim 15, wherein transmitting the first portion of the torque of the rotating system thereby dampens a torsional vibration between the first end of the outer sleeve and a first end of the inner sleeve.

20. The method of claim 15, wherein the circumferentially-periodic pattern is triangular.
